(19) United States
(12) Patent Application Publication
(10) Pub. No.: US 2024/0140056 A1
(43) Pub. Date: May 2, 2024

(54) A STRUCTURAL REPAIR PATCH SYSTEM FOR REPAIRING A DAMAGED SURFACE OF A PRODUCT

(71) Applicants: Clinton Hollier, Lennox Head (AU); Paul Daly, Lennox Head (AU)

(72) Inventors: Clinton Hollier, Lennox Head (AU); Paul Daly, Lennox Head (AU)

(21) Appl. No.: 18/280,151

(22) PCT Filed: Mar. 4, 2022
(86) PCT No.: PCT/AU22/50182

§ 371 Date: Sep. 1, 2023

(30) Foreign Application Priority Data
Mar. 4, 2021 (AU) 2021900601

(51) Int. Cl. B29C 73/10; B63B 32/70; B63B 81/00

(52) U.S. Cl. CPC B29C 73/10; B63B 32/70; B63B 81/00

(57) ABSTRACT

A structural repair patch system for repairing a damaged product surface, the system comprising: an application member, a patch member and at least one containing member. The patch member further comprises a reinforced element with a reinforced element top surface and a reinforced element bottom surface, an adhesive element incorporated into the reinforced element and or positioned on the reinforced element bottom surface and a smooth surface element, located on the reinforced element top surface, which is conformable to the surface and texture of an undamaged surface of the product. The at least one containing member forms a sealed enclosure containing the patch member.

### CROSS-REFERENCE TO RELATED APPLICATIONS

This patent application claims priority to and all the benefits of AU Patent Application No. AU2021900601 filed on Mar. 4, 2021, and International App. No. PCT/AU2022/050182 filed on Mar. 4, 2022, which are herein incorporated by reference in their entirety.

### FIELD OF THE INVENTION

The present invention relates generally to a system and process for repairing a damaged surface of a product, and in particular but not exclusively to repairing a surfboard or other water sports product.

### BACKGROUND

Construction of most surfboards starts with a foam core in the rough shape of a surfboard. The foam core is shaped with a variety of tools forming the desired shape of the finished board. The foam core is then covered with a reinforced skin commonly consisting of fibreglass cloth and polyester resin. Commonly an extra coat or coats of resin is applied to the board and once cured sanded to give a smooth finish.

The reinforced skin component is a fundamental element in the board's strength, stiffness, and durability. Damage to the reinforced skin component can significantly reduce the board's strength. Minor damage to a small area of the reinforced skin component, especially in a critical area towards the middle of the board, can create a weak point resulting in catastrophic structural failure and snapping of a board during use.

In addition to providing the final visual aesthetic, the reinforced skin component also fulfils the role of a waterproof barrier. If the reinforced skin component is compromised, water can penetrate into the foam core thereby increasing the surfboard's weight and decreasing its performance. Furthermore, long term exposure of the foam core to water can result in rotting, softening and discolouring of the foam core and consequently reducing the lifespan and resale value of the surfboard.

The reinforced skin component also provides the contact surfaces between the board and the user, and the board and the water. Commonly, the reinforced skin is sanded to provide a smooth or even gloss finished surface as well as reducing drag at the water/reinforced skin component interface.

Although being relatively strong and durable it is common for surfboards to be damaged during use and transport to and from surf locations. While being used, it is possible for a board to suffer an impact with for example a submerged object, whether a rock or a coral reef, other surfboard or even an unintentional impact with the person riding the board. During transport, boards are often damaged by not being fully secured in a vehicle or dropped onto a hard surface when loading and unloading or when other heavy objects are placed on top of boards. The latter is particularly common during air travel when a board is packed by third party baggage handlers.

A common example of damage to surfboards consists of an impact with a hard object, wherein the impact causes the reinforced skin component to flex beyond its elasticity limits resulting in the reinforced skin component cracking. The foam core, being more flexible than the skin component, often compresses under the impact and then returns to its original shape. The resulting cracks through the reinforced skin component can compromise the surfboard's strength and allow water to penetrate the foam core. Consequently, the surfboard needs to be repaired before further use.

It is common for surfers to take a holiday with the sole purpose of surfing. An example of such a holiday is when people travel to surf locations around the world to stay at a surf resort or on a surf charter boat. Due to the often considerable cost of such holidays, if surfboards are damaged while traveling to a surf destination, they often need to be repaired on the spot before being used and despite being in a location where the necessary tools, supplies, or professional repair services may not be readily available.

Professional repairers may not be easily accessible in every surf location and therefore professional repair services are not always an option. Another shortcoming associated with professional repairers is the downtime required for repairing damaged surfboards, where a damaged surfboard may need to be left in a repair shop for a substantial period such as 1 to 2 weeks. Therefore, there is a need for a fast and easy repair method which can be used in situ without necessitating specific equipment or technical expertise.

Commercially available surfboard repair kits often comprise woven glass reinforcements, polyester resin, and sometimes sand paper and skin protective gloves. A shortcoming of these surfboard repair kits often resides in the equipment and technical skills needed to perform the repair. For example coarse sanding of the damaged skin reinforcement for prepping the repair area, shaping the glass reinforcements to suit the damaged skin reinforcement, mixing the toxic chemical components of the polyester resin in the appropriate proportion, applying the polyester resin evenly to the glass reinforcements, removing the excess polyester resin to prevent the glass reinforcements from floating to the top and having a reduced strength repair, and producing a surface finish that resembles the pre damaged surface using several finer grades of sandpaper. This can be problematic because, as previously stated the required equipment is often difficult to travel with. Furthermore, such complex repair methods generally require sound technical knowledge of working with resin and fibreglass reinforcements in order to achieve a satisfactory repair which is mechanically sound. In addition, such methods of repair can be very labour intensive, necessitating multiple sanding steps required to produce a smooth surface finish of the undamaged skin of the board. Moreover, any tool or equipment that comes in contact with uncured resin requires cleaning in a solvent before being stored and or used again. Without the appropriate cleaning, any tool or equipment may be unusable after a single use, thereby creating a lot of waste. Such methods of repair are in most cases best carried out by a professional surfboard repair professional in a factory environment and are not a viable option while travelling.

Another common repair method concerns using a resin pre-mixed with glass fibres. The pre-mixed resin, commonly provided in a small tube, can be applied to the damaged area. However, the structural integrity of the repaired area can be compromised due to the reinforced glass fibres in the pre-mixed resin being randomly aligned and not in a woven form. Furthermore, it can be particularly difficult to achieve a smooth finish surface finish while using such methods as the applied resin does not cure with a smooth surface finish, thereby requiring multiple sanding steps which can be time consuming and difficult to achieve without adequate technical knowledge and equipment. Due to the nature of working with a liquid resin on a curved shape of a surfboard, it is intrinsically difficult for a non-expert to ascertain the required amount of resin for the repair and effectively apply the uncured liquid resin to the finished shape as required.

There is therefore a need for an improved structural repair patch system for repairing a damaged surface of a product.

### OBJECT OF THE INVENTION

It is an object of the present invention to overcome and/or alleviate one or more of the disadvantages of the prior art or provide the consumer with a useful or commercial choice.

### SUMMARY OF THE INVENTION

In a first aspect, although it need not be the only or the broadest aspect, the invention resides in a structural repair patch system for repairing a damaged surface of a product, the system comprising:

an application member;

a patch member comprising:

a reinforced element wherein the reinforced element has a reinforced element top surface and a reinforced element bottom surface;

an adhesive element, wherein the adhesive element is incorporated into the reinforced element or positioned on the reinforced element bottom surface; and

a smooth surface element, wherein the smooth surface element is located on the reinforced element top surface, and is conformable to the surface and texture of an undamaged surface of the product; and

at least one containing member, wherein the at least one containing member forms a sealed enclosure containing the patch member.

Preferably, the application member comprises a surface that extends beyond the perimeter of the patch member, whereby the application member retains elements of the patch member within the damaged product surface.

Preferably, the application member is attached to the patch member with a second adhesive element; and wherein an adhesion strength of the second adhesive element is lower than an adhesion strength of the adhesive element.

Preferably, the application member comprises a smooth surface finish and remains an element on the patch member once the adhesive element is cured.

Preferably, the application member is flexible to enable the patch member to be conformed to the shape of the damaged product surface.

Preferably, the application member has an adhesive property whereby the repair patch can be positioned and held in place on the product surface.

Preferably, the application member is transparent to UV light and visible light whereby the repair patch can be positioned on the damaged product surface and UV light can be used to cure the adhesive element.

Preferably, the reinforced element comprises: fibres, glass fibres, Kevlar, carbon, plastic fibres, hemp, cotton, flax, nylon, polyester or wood veneer.

Preferably, the reinforcement element comprises woven fibres or a non-directional random distribution of fibres.

Preferably, the reinforcement element comprises Polyester or Epoxy resin in a cured or uncured state.

Preferably, the adhesive element can be cured by exposure to UV light.

Preferably, the adhesive element can be cured from a liquid state.

Preferably, the adhesive element comprises Polyester or Epoxy resin.

Preferably, the smooth surface element comprises a thin plastic film.

Preferably, the smooth surface element comprises a liquid that conforms to the shape and texture of a surface of the application member that can be cured to a solid state forming the smooth surface element of the patch member.

Preferably, the smooth surface element comprises a liquid that also forms the adhesive element of the patch member.

Preferably, the sealed enclosure prevents UV light from reaching the patch member.

Preferably, the sealed enclosure prevents liquids or gases from entering and exiting the sealed enclosure

In another aspect, the invention resides in a process of applying the above described structural repair patch system, the process of applying comprising: curing the adhesive element to form a mechanical bond between the reinforced element, the smooth surface element and the damaged product surface.

In another aspect, the invention resides in a process of forming the above described structural repair patch system, the process of forming comprising: forming the sealed enclosure by joining a removable attachment to the application member with a fastening surface.

Preferably, the process of forming the structural repair patch comprises the fastening surface forming an adhesive seal.

Preferably, the process of forming the structural repair patch comprises defining the fastening surface by a mechanical fastener.

Preferably, the process of forming the structural repair patch comprises forming the sealed enclosure by compressing a surface of a containing member against an opposing surface of the application member.

Preferably, the process of forming the structural repair patch comprises compressing of surfaces by a vacuum.

Preferably, the process of forming the structural repair patch comprises compressing of surfaces by mechanical means.

Preferably, the top surface of the patch member: is shaped as an ellipse, is convex, or is conical.

Preferably, the product is a surfboard or other water sports product.

Preferably, the product is a marine vessel.

### BRIEF DESCRIPTION OF THE DRAWINGS

To assist in understanding the invention and to enable a person skilled in the art to put the invention into practical effect, preferred embodiments of the invention are described below by way of example only with reference to the accompanying drawings, in which:

FIG. 1 shows a top plan view of one form of a structural repair patch.

FIG. 2 is a sectional side elevation of the repair patch shown in FIG. 1.

FIG. 3 is a pictorial view of a surfboard with damage to the surface skin.

FIG. 4 is a pictorial view of a surfboard with repair patches being applied.

FIG. 5 is a pictorial view of a surfboard with completed repairs.

FIG. 6 is a cross-sectional view of a surfboard rail with a repair patch being applied.

FIG. 7 is a cross-sectional view of a surfboard rail with a repair completed.

FIG. 8 is a sectional side elevation of an example of a structural repair patch system of this invention.

FIG. 9 is a sectional side elevation of an example of a structural repair patch system of this invention.

FIG. 10 is a sectional side elevation of an example of a structural repair patch system of this invention.

FIG. 11 is a sectional side elevation of an example of a structural repair patch system of this invention.

FIG. 12 is a sectional side elevation of an example of a structural repair patch system of this invention.

FIG. 13 is a sectional side elevation of an example of a structural repair patch system of this invention.

FIG. 14 is a sectional side elevation of an example of a structural repair patch system of this invention.

FIG. 15 is a sectional side elevation of an example of a structural repair patch system of this invention.

FIG. 16 is a sectional side elevation of an example of a structural repair patch system of this invention.

FIG. 17 is a pictorial view of another form of this invention where a repair patch is in a contoured 3-D form.

### DETAILED DESCRIPTION OF THE PREFERRED EMBODIMENT

The present invention relates to a structural repair patch system for repairing a damaged product surface. Elements of the invention are illustrated in concise outline form in the drawings, showing only those specific details that are necessary to understanding the embodiments of the present invention, but so as not to clutter the disclosure with excessive detail that will be obvious to those of ordinary skill in the art in light of the present description.

In this patent specification, adjectives such as first and second, left and right, above and below, top and bottom, upper and lower, rises and falls, upward and downward, etc., are used solely to define one element or method step from another element or method step without necessarily requiring a specific relative position or sequence that is described by the adjectives. Words such as “comprises” or “includes” are not used to define an exclusive set of elements or method steps. Rather, such words merely define a minimum set of elements or method steps included in a particular embodiment of the present invention.

According to one aspect, the present invention is defined as a structural repair patch system for repairing a damaged surface of a product, the system comprising:

an application member;

a patch member comprising:

a reinforced element wherein the reinforced element has a reinforced element top surface and a reinforced element bottom surface;

an adhesive element, wherein the adhesive element is incorporated into the reinforced element and or positioned on the reinforced element bottom surface; and

a smooth surface element, wherein the smooth surface element is located on the reinforced element top surface, and is conformable to the surface and texture of an undamaged surface of the product; and

at least one containing member, wherein the at least one containing member forms a sealed enclosure containing the patch member.

Advantages of some embodiments of the present invention include providing a structural repair patch system for repairing a damaged product such as a surfboard surface that can be readily deployed without necessitating any specific equipment or expertise, in a short amount of time. The structural repair patch system includes components such as an application member, a patch member comprising a reinforced element, an adhesive element and a surface finish element, in a single sealed containing element which is easy to transport. The structural repair patch system thus enables the permanent repair of a damaged product with a surface finish conforming to the original product and without necessitating sanding.

Those skilled in the art will appreciate that not all of the above advantages are necessarily included in all embodiments of the present invention.

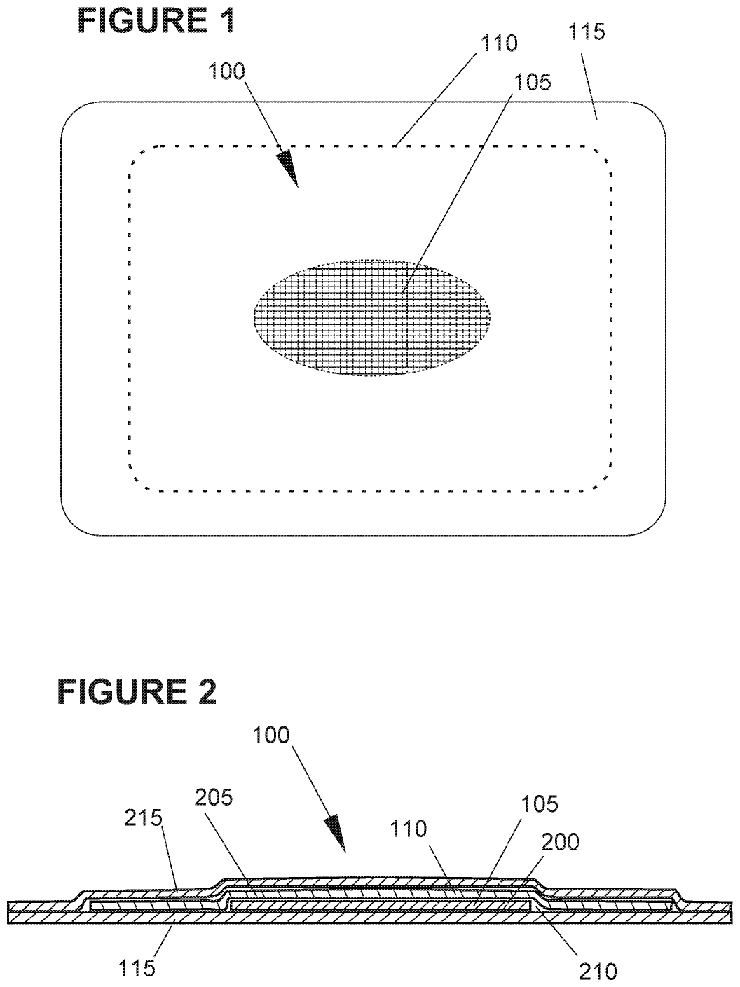

FIG. 1 is a top plan view of one form of a structural repair patch system 100. The structural repair patch system 100 includes a reinforced element 105 in an elliptical shape and an application member 110, all contained in a containing member 115.

Referring to FIG. 2, a side elevation of the structural repair patch system 100 is shown. The reinforced element 105 is positioned between an adhesive element 200 and a smooth surface element 205, in an enclosure 210 formed between the application member 110 and the containing member 115. A containing member 215 forms a removable cover.

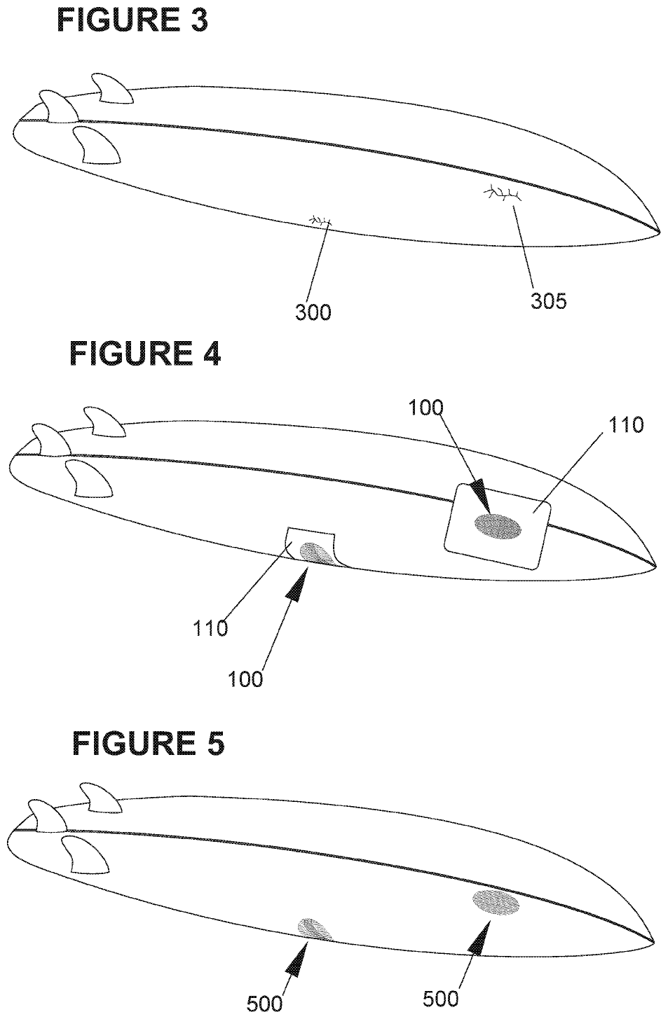

Referring to FIG. 3, an elevated view is shown of a surfboard with a first damaged surface 300 on a curved edge of the surfboard skin and a second damaged surface 305 on a flatter area of the surfboard skin.

FIG. 4 shows an elevated view of a surfboard with the structural repair patch system 100 being applied and held to the contours of the surfboard surface by application member 110.

FIG. 5 shows an elevated view of a surfboard with completed repairs where a patch member 500 is bonded to the board's surface. The patch member 500 includes the reinforced element 105, the adhesive element 200, and the smooth surface element 205.

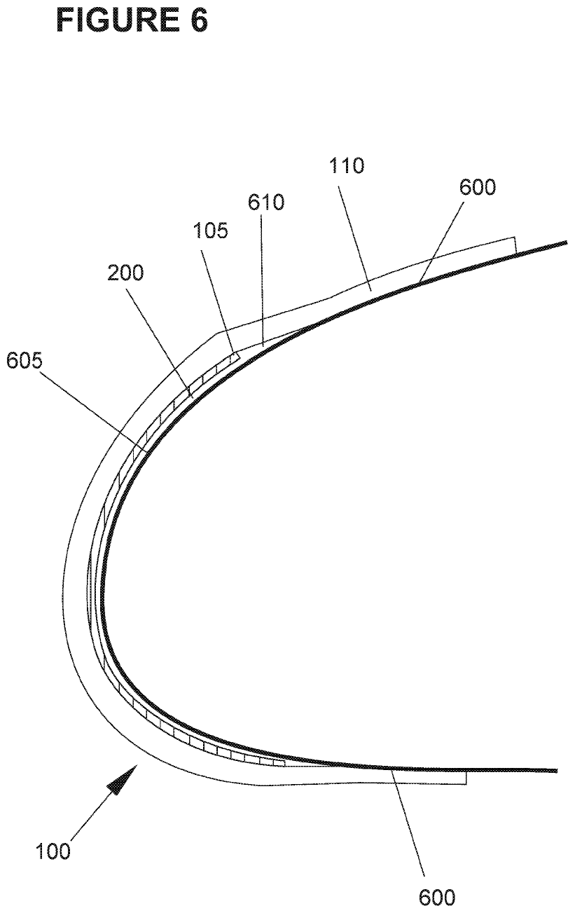

FIG. 6 shows a cross-sectional view of a surfboard rail with the structural repair patch system 100 being held to the contour of the board surface 605 by the application member 110 having an adhesive surface 600. The adhesive element 200 filling the void between the edge of the reinforced element 105, a surfboard surface 605 and the application member 110 creates a blended edge 610.

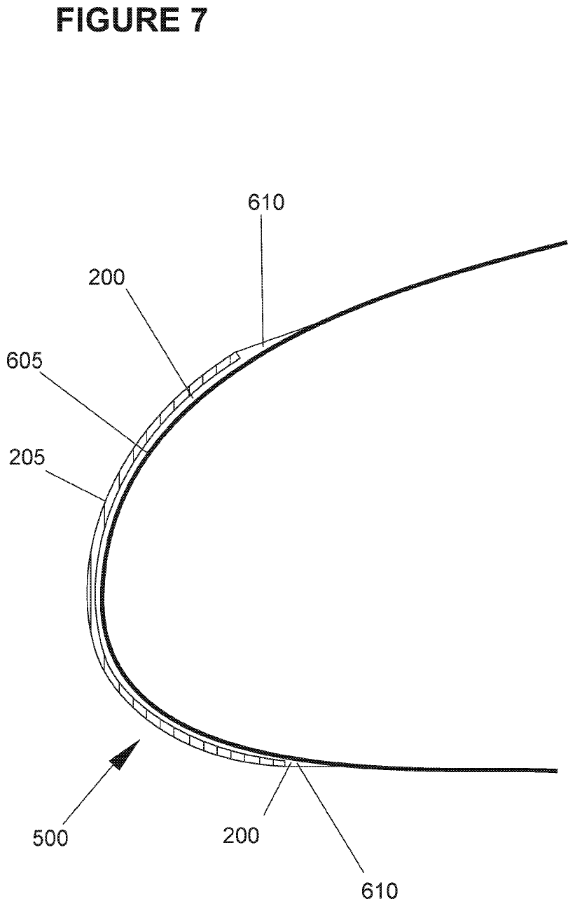

FIG. 7 shows a cross-sectional view of the surfboard rail shown in FIG. 6 with the repair completed. The patch member 500 is bonded to the surfboard surface 605. The smooth surface element 205 bonds to the surfboard surface 605 by the adhesive element 200 forming the blended edge 610.

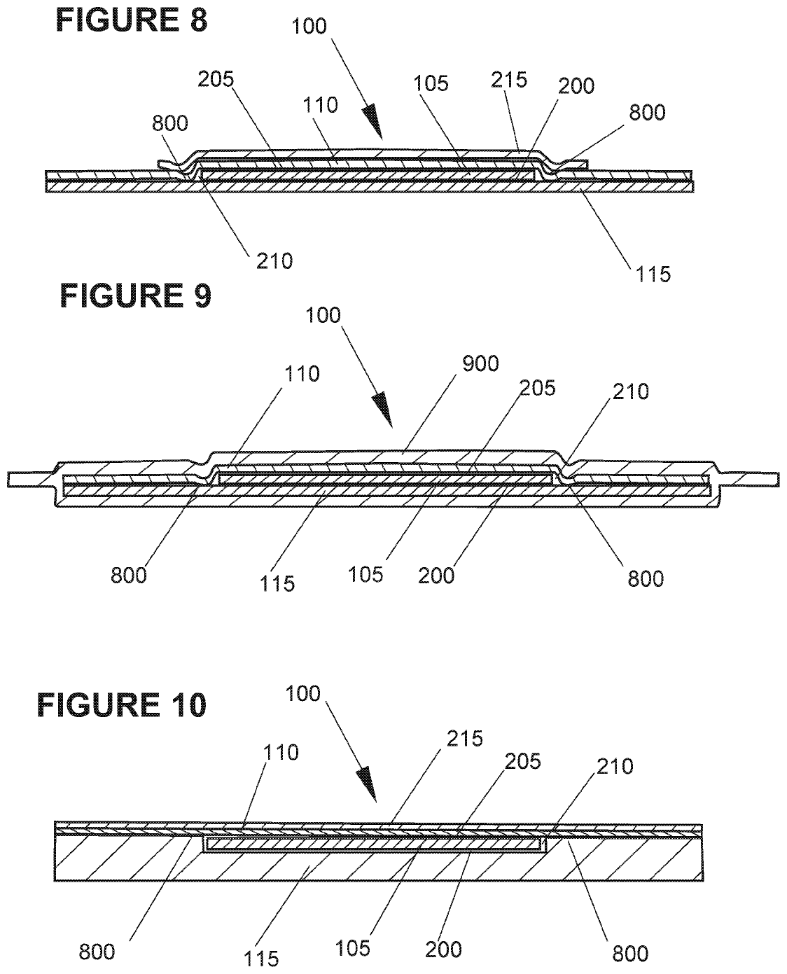

FIG. 8 shows a side elevation of the structural repair patch system 100, detailing the reinforced element 105, the adhesive element 200 and the smooth surface element 205, in the enclosure 210. The enclosure 210 is formed between the application member 110 and a sealing surface 800 of the containing member 115. The containing member 215 forms a removable cover, opaque to UV light.

FIG. 9 shows a side elevation of another example application of the structural repair patch system 100, detailing reinforced element 105, the adhesive element 200 and smooth surface element 205, in the enclosure 210, formed between the application member 110 and the sealing surface 800 of the containing member 115. A containing member 900 forms a surrounding barrier that may be sealed under vacuum.

FIG. 10 shows a side elevation of another example application of the structural repair patch system 100, detailing the reinforced element 105, the adhesive element 200 and the smooth surface element 205, in the enclosure 210. The enclosure 210 is formed between the application member 110 and the sealing surface 800 of the containing member 115. The containing member 215 forms a removable UV light blocking cover.

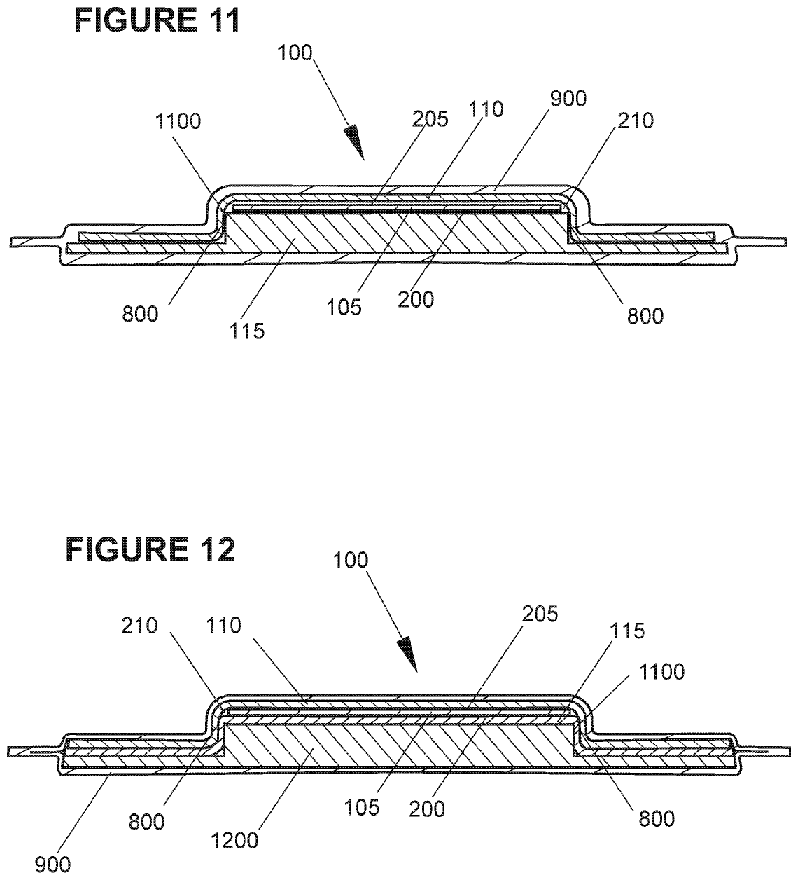

FIG. 11 shows a side elevation of yet another example application of the structural repair patch system 100, detailing the reinforced element 105, the adhesive element 200 and the smooth surface element 205, in the enclosure 210 formed between the application member 110 and the sealing surface 800 of the containing member 115. The containing member 900 forms a surrounding barrier that may be sealed under vacuum to provide a mechanical means of sealing the enclosure at the sealing surface 800. The sealing surface 800 of the containing member 115 forms a defined ridge-like shape 1100 improving the seal of the enclosure 210.

FIG. 12 shows a side elevation of another example application of the structural repair patch system 100, detailing the reinforced element 105, the adhesive element 200 and the smooth surface element 205, in the enclosure 210 formed between the application member 110 and the sealing surface 800 of the containing member 115. The containing member 900 forms a surrounding barrier that may be sealed under vacuum to provide a mechanical means of sealing the enclosure 210, at the sealing surface 800, by compressing the containing member 115 against the application member 110. In this application of the structural repair patch system 100, a containing member 1200 forms the ridge like shape 1100, improving the seal of the enclosure 210.

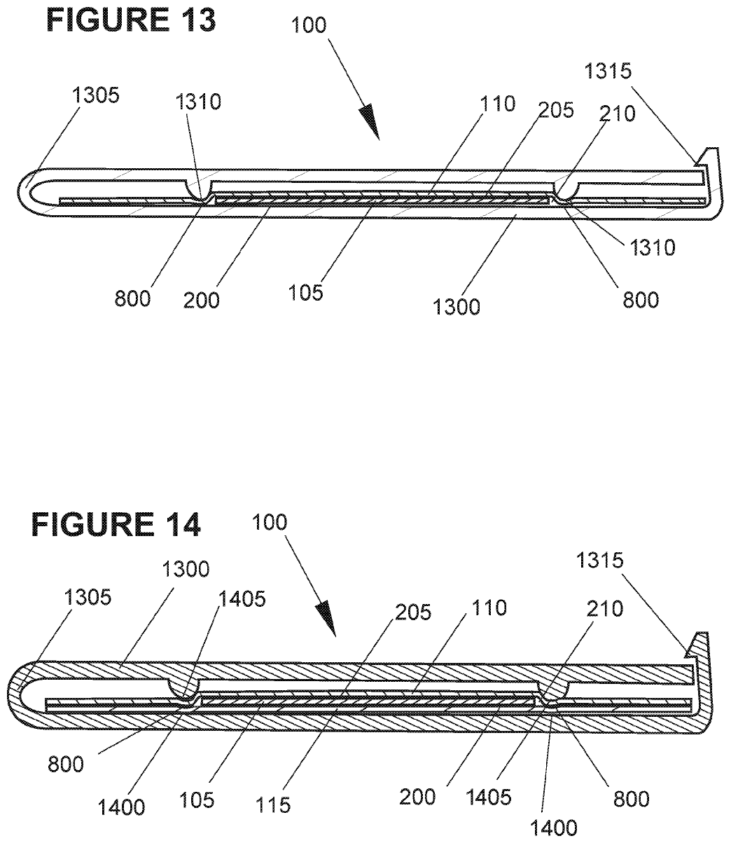

FIG. 13 shows a side elevation of another example application of the structural repair patch system 100, detailing the reinforced element 105, the adhesive element 200 and the smooth surface element 205, in an enclosure 210. The enclosure 210 is formed between the application member 110 and the sealing surface 800 of the containing member 1300. The containing member 1300 forms a mechanical means of sealing the enclosure at the sealing surface 800. In this application of the structural repair patch system 100, the containing member 1300 is bent around a flex point 1305, thereby applying a compressive force on the application member 110 between the surface 1310 and surface 800 of containing member 1300. The application member 110 is compressed by the containing member 1300, being held in this position by means of a mechanical fastener 1315.

FIG. 14 shows a side elevation of another example application of the structural repair patch system 100, detailing the reinforced element 105, the adhesive element 200 and the smooth surface element 205 in an enclosure 210. The enclosure 210 is formed between the application member 110 and the sealing surface 800 of the containing member 115. The containing member 115 forms a mechanical means of sealing the enclosure 210 at the sealing surface 800. In this application of the structural repair patch system 100, the containing member 1300 is bent around the flex point 1305, thereby applying a compressive force on the application member 110 and containing member 115 between the surface 1400 and surface 1405 of the containing member 1300. The application member 110 and containing member 115 are held in compression at the contact point 800, between the surface 1400 and the surface 1405, by the containing member 1300, being held in this position by means of mechanical fastener 1315.

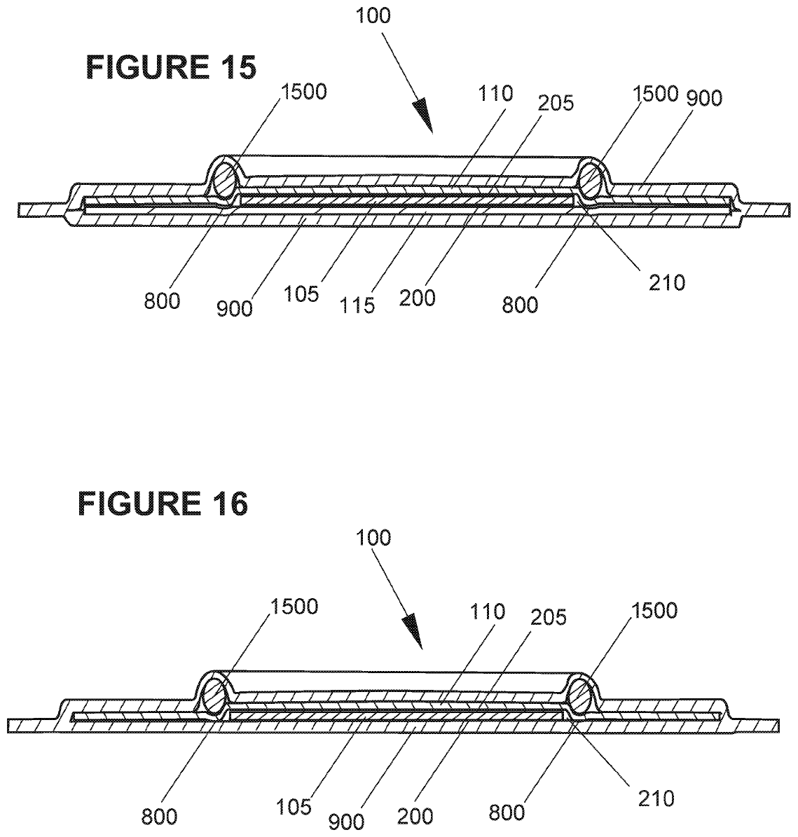

FIG. 15 shows a side elevation of another example application of the structural repair patch system 100, detailing the reinforced element 105, the adhesive element 200 and the smooth surface element 205, in an enclosure 210. The enclosure 210 is formed between the application member 110 and the sealing surface 800 of the containing member 115. The containing member 900 forms a surrounding barrier that may be sealed under vacuum as a mechanical means of sealing the enclosure at the sealing surface 800, by compressing the containing member 1500 against the containing member 115 with the application member 110 being compressed in between, at sealing surface 800.

FIG. 16 shows a side elevation of another example application of the structural repair patch system 100, detailing the reinforced element 105, the adhesive element 200 and the smooth surface element 205, in an enclosure 210. The enclosure 210 is formed between the application member 110 and the sealing surface 800 of the containing member 900. The containing member 900 forms a surrounding barrier that may be sealed under vacuum to provide a mechanical means of sealing the enclosure at the sealing surface 800 by compressing the containing member 1500 against the containing member 900 with the application member 110 being compressed between at sealing surface 800.

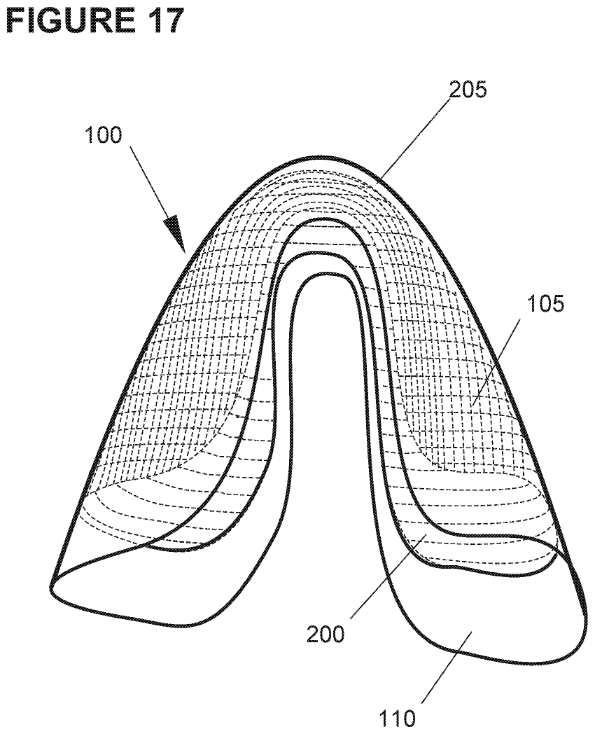

FIG. 17 is a perspective view of another example application of the structural repair patch system 100, where the structural repair patch system 100 has a conical shape allowing it to be easily conformed to the nose or tail shape of a surfboard. FIG. 17 shows the reinforced element 105, the adhesive element 200, the smooth surface element 205 and application member 110, all conforming to the same conical shape.

A person skilled in the art will appreciate that the present invention is not limited to surfboards and can be implemented on various types of water sport boards, such as for example windsurfing boards, kitesurfing boards and body boards, or on other products that require surface repairs of a similar nature, including marine vessels. Furthermore, a person skilled in the art will appreciate that the shape and size of the patch member can be tailored to conform to the shape and size of different types of surfboard skin damage, which could be for example puncture damage, scratch damage extending longitudinally or any combination of the aforementioned types of surfboard skin damage. Consequently, the patch member can be convex or conical or shaped as an ellipse, although other shapes also could be envisioned.

A person skilled in the art will further appreciate that a reinforcement element, such as element 105, is preferably made of woven glass fibres. However, other suitable fibre materials such as Kevlar, carbon fibres, plastic fibres, hemp, cotton, flax, nylon, polyester fibre or wood veneer could be substituted to the woven glass fibres. Furthermore, while woven fibre material with full length fibres is generally advantageous, woven fibre in the form of chop strand mat also could be used. Another example of said reinforced element comprises a curable resin that when cured forms a solid that provides structure to the patch. Examples of such resin include, but are not limited to, polyester resin or epoxy resin.

A person skilled in the art will appreciate that an adhesive element, such as element 200, in accordance with the present invention may consist of any adhesive that when cured will form a bond between the repair patch and the surface of the damaged product. One example of such adhesive element is a polyester resin, and another example is an epoxy based resin. Other resin substitutes fulfilling the same role, with suitable mechanical and chemical properties (i.e. water resistant) can be envisioned. In another embodiment of the present invention, the adhesive element forms a bond between the reinforced element and the damaged surface of the product. In still another embodiment of this invention, said adhesive element is a measured amount in a specified ratio to the size of the repair patch, enabling an optimal strength bond between the patch and the damaged surface. In yet another embodiment of the present invention, said adhesive element is in a viscous state when uncured, enabling the uncured adhesive element to conform to the surface and texture of the area to be repaired. This also enables said adhesive to fill the small void between the edge of the patch, the product surface and the application element, creating a blended edge for the repair, and thereby reducing the need for sanding. In a further embodiment of this invention, said adhesive element may be cured by exposure to UV light, whether generated by a UV light source or through the UV radiation emitted by the sun.

A person skilled in the art will appreciate that a smooth surface element, such as element 205, should generally comprise a smooth surface on at least one side of the patch to provide a repair surface that matches the undamaged surface of the product. In another embodiment of this invention, said smooth surface element is a thin plastic film comprising cured resin or a cured resin and an additional fibre reinforced element, for example glass fibres. In yet another embodiment of this invention, the smooth surface element is a thin film, whether a polymer or any other suitable material, the mechanical properties (i.e. mechanical strength and linear thermal expansion coefficient for example) of which match those of the surface of the product and provide a waterproof barrier once applied to the damaged area of the product. In another embodiment of this invention, the smooth surface element is formed by uncured resin conforming to the shape and texture of the application member and then cured to form a waterproof and smooth solid surface.

In another embodiment of the present invention, the reinforced element, the adhesive element and the smooth surface element can be a single component that form all three functions or multiple components. An example of such a single component is a resin that when cured forms a reinforced element, an adhesive element and a smooth surface element. Examples of such resin may include but are not limited to polyester resin and epoxy resin.

A person skilled in the art will further appreciate that an application member, such as application member 110, enables the patch to be conformed and held against the repair surface while the patch is bonding to the product. The application member provides a barrier between the patch and the repairer's hands, enabling the repairer to carry out the application without getting adhesive elements on their hands. The application member preferably comprises a surface that extends beyond the perimeter of the repair patch, as shown for example in FIG. 6, thereby enabling the application member to contain all elements of the patch member within the repair area. In another embodiment of this invention, the surface of the application member has an adhesive surface, such as element 600, that enables the repair patch to be positioned and held firmly in place on the surface of the product. Furthermore, the application member can be flexible to enable the patch to be conformed to the shape of the product, and has elastic properties enabling a repair person to apply pressure when holding the patch firmly against the damaged surface to promote bonding of the adhesive member onto the damaged surface and create a good bond. Thus in some embodiments the adhesive member also conforms to the shape of the damaged surface of the product. Furthermore, the application member can be made of several parts, assembled together, before the application of the repair patch against the repair surface, and allowed to separate once the repair is finalized, thereby allowing easier removal of the application member.

In another embodiment of this invention, the adhesive element is a UV curable resin. Therefore, the application member can be made of a material that allows UV light to pass through the application member to cure the adhesive element.

In another embodiment of this invention, the adhesive element is a heat curable resin, such as but not limited to a phenolic resin. Therefore, the application member can be made of a heat conducting material, allowing heat to be applied by a heat gun, a hair dryer or an iron, for example, to penetrate through the application member and cure the adhesive member.

In another embodiment of this invention, the application member is attached to the patch member, holding the patch in place during transport, storage and during the repair process. Preferably, the patch member is attached to the application member with a releasable adhesive allowing the patch member to be released from the application member without impacting the structural integrity of the adhesive member between the repair patch and the surface of the surface of the product once the latter has been cured. Alternatively, the application member forms the smooth surface element and remains on the patch once the adhesive element has been cured. In another embodiment of this invention, the application member is transparent to visible light, thereby allowing a repairer to see through it so that the repairer can see the positioning of the patch member while carrying out the repair. In yet another embodiment of this invention, the application member is thin and pliable so that any trapped air can be worked out of the patch area by the repairer's hands. In another embodiment of this invention, the application member comprises of a thin flexible clear film made of polyurethane or any other materials with substantially similar mechanical and optical properties such as for example polyethylene, PVC, silicon or latex.

Those skilled in the art will further appreciate that a containing member, such as containing member 115, may be defined in various forms and/or combinations of parts and materials, enabling the repair patch to be transportable and ready to use when needed. In one embodiment of this invention said containing member forms a sealed enclosure that retains the repair patch in a sealed environment, shown for example in FIGS. 8-16. Alternatively, the sealed enclosed is hermetically sealed. The sealed enclosure prevents air, moisture, and UV light from impacting the patch as well as minimizing any losses of liquids, gases and vapours from the adhesive element, prolonging the usable life of the structural repair patch. In another embodiment of this invention, the sealed enclosure is sealed under vacuum or sealed after all excess air is removed, prolonging the usable life of the adhesive element. In yet another embodiment of this invention, a gas or a liquid may be added to the enclosure after all excess air is removed in order to extend the shelve life of the packaged structural repair patch. Examples of gas include but are not limited to oxygen, nitrogen and argon. Additionally, the containing member may comprise various materials to form the sealed enclosure. Examples of such materials include, but are not limited to, laminated aluminium, mylar plastic sheet or foil coated cardboard. Numerous different metals, plastics, paper, wood and various combinations thereof also could be used.

Those skilled in the art will further appreciate that the containing member may include a sealing surface, such as the sealing surface 800, with a removable attachment to the application member, forming a sealed enclosure containing the repair patch and allowing for the enclosure to be opened when the repair patch is to be applied to the product. In another embodiment of this invention, the sealing surface comprises a surface that extends beyond the perimeter of the repair patch member, thereby enabling the application member to be removably attached to the containing member on the surface surrounding the patch member forming a sealed enclosure containing all elements of the structural repair patch. An example of such a removable attachment concerns using the adhesive property of the surface of the application member. Another example of the removable attachment concerns using an adhesive seal. Yet another example of the removable attachment concerns by mechanical means holding the surface of the application member against the sealing surface of the containing member to form the sealed enclosure, as shown for example in FIG. 13. Another example of the removable attachment comprises a combination of mechanical fastening means and or adhesives. An example of mechanical fastening means comprises holding the surface of the application member against the sealing surface of the containing member by applying a vacuum to the sealed enclosure prior to sealing. Another example of mechanical fastening means to hold the surface of the application member against the sealing surface of the containing member to form the sealed enclosure comprises a vacuum sealed enclosure surrounding the application member and the sealing surface of the containing member that is sealed while a vacuum force is applied. A further example of mechanical fastening means to hold the surface of the application member against the sealing surface of the containing member to form the sealed enclosure comprises a vacuum enclosure compressing a seal on the opposite side of the application member to the sealing surface of the containing member effectively creates a sealed enclosure between the application member and the sealing surface of the containing member. Another example of said mechanical fastening means comprises holding the surface of the application member against the sealing surface of the containing member by means of a snap fit, clip, fastener, crimp, fold, weld, clamp, spring, mechanical bias or any combination thereof. The mechanical fastening means may be applied directly to the application member or applied through another part of the containing member.

In another embodiment of this invention, the sealing surfaces of the application member or the containing member or the surfaces applying the mechanical force comprise a resilient material that conforms to the shape of its opposing surface when compressed, as shown for example in FIGS. 15 and 16. Examples of resilient materials include but are not limited to expanded polystyrene, ethylene propylene diene monomer rubber and silicon foam. In another embodiment of this invention, the removable attachment, the sealing surfaces of the application member, the containing member or the surfaces applying the mechanical force has a specific shape with a step or a ridge, such as ridge 1100, in the sealing surface of the containing member, thereby creating a defined seal to form the enclosure with the application member. A combination of resilient materials, adhesive surfaces, and the shape of the sealing surfaces of the application member or the containing member or the surfaces applying the mechanical force is also possible.

In another embodiment of this invention, the sealed enclosure may be formed by the application member forming an enclosure around the repair patch member. One example is having the application member having surfaces that extend beyond the perimeter of the repair patch and reattach to itself by means of removable attachment. Another example is having the application member form an enclosure by effectively folding back on itself. Another example of having the application member form an enclosure is by forming a roll on itself where the repair patch is enclosed between surfaces or layers of the application member.

In another embodiment of this invention, the sealed enclosure contains more than one patch member and at least one application member.

In another embodiment of this invention, the containing member may comprise a UV blocking element that may be part of or separate to the sealing surface of the containing member, which can prevent UV light from entering the repair patch enclosure through the application member. An example of a UV light blocking element is at least one surface that extends from the sealing surface of the containing member and covers the application member and prevents UV light entering the repair patch. Another example of UV light blocking element is a removable cover that attaches to the application member, or to the containing member or both to form a cover. Said removable cover may be a thin sheet material that is removably adhered to the enclosure. An example would be a removable sticker. Another example of removable cover may comprise a component that clips or fastens to the enclosure. Yet another example of UV light blocking element is a sleeve, container or satchel that can form a UV light barrier and surround the sealed enclosure containing the patch member. The satchel can comprise a material that is impervious to liquids, gases, vapours and UV light to prolong the usable life of the repair patch, such as for example laminated aluminium or mylar plastic sheet.

The above description of various embodiments of the present invention is provided for purposes of description to one of ordinary skill in the related art. It is not intended to be exhaustive or to limit the invention to a single disclosed embodiment. Numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. Accordingly, this patent specification is intended to embrace all alternatives, modifications and variations of the present invention that have been discussed herein, and other embodiments that fall within the spirit and scope of the above described invention.

1.-28. (canceled)

29. A structural repair patch system for repairing a damaged surface of a product, the system comprising:
an application member;
a patch member comprising:
a reinforced element wherein the reinforced element has a reinforced element top surface and a reinforced element bottom surface;
an adhesive element, wherein the adhesive element is incorporated into the reinforced element or positioned on the reinforced element bottom surface; and
a smooth surface element, wherein the smooth surface element is located on the reinforced element top surface, and is conformable to the surface and texture of an undamaged surface of the product; and
at least one containing member, wherein the at least one containing member forms a sealed enclosure containing the patch member.

30. The system of claim 29, wherein the application member comprises a surface that extends beyond the perimeter of the patch member, whereby the application member retains elements of the patch member within the repair area of the damaged product surface.

31. The system of claim 29, wherein the application member is attached to the patch member with a second adhesive element; and
wherein an adhesion strength of the second adhesive element is lower than an adhesion strength of the adhesive element.

32. The system of claim 29, wherein the application member comprises a smooth surface element and remains an element on the patch member once the adhesive element is cured.

33. The system of claim 29, wherein the application member is flexible to enable the patch member to be conformed to the shape of the damaged product surface.

34. The system of claim 29, wherein the application member has an adhesive property whereby the repair patch can be positioned and held in place on the product surface.

35. The system of claim 29, wherein the application member is transparent to UV light and visible light whereby the repair patch can be positioned on the damaged product surface and UV light can be used to cure the adhesive element.

36. The system of claim 29, wherein the reinforced element of the patch member comprises: fibres, glass fibres, Kevlar, carbon, plastic fibres, hemp, cotton, flax, nylon, polyester or wood veneer.

37. The system of claim 29, wherein the reinforcement element comprises woven fibres or a non-directional random distribution of fibres.

38. The system of claim 29, wherein the reinforcement element comprises Polyester or Epoxy resin in a cured or uncured state.

39. The system of claim 29, wherein the adhesive element can be cured by exposure to UV light.

40. The system of claim 29, wherein the adhesive element can be cured from a liquid state.

41. The system of claim 29, wherein the adhesive element comprises Polyester or Epoxy resin.

42. The system of claim 29, wherein the smooth surface element comprises a thin plastic film.

43. The system of claim 29, wherein the smooth surface element comprises a liquid that conforms to the shape and texture of a surface of the application member that can be cured to a solid state forming the smooth surface element of the patch member.

44. The system of claim 43, wherein the smooth surface element comprises a liquid that also forms the adhesive element of the patch member.

45. The system of claim 29, wherein the sealed enclosure prevents UV light from reaching the patch member.

46. The system of claim 29, wherein the sealed enclosure prevents liquids or gases from entering and exiting the sealed enclosure.

47. A process of applying the structural repair patch system of claim 29, the process comprising: curing the adhesive element to form a mechanical bond between the reinforced element, the smooth surface element and the damaged product surface.

48. A process of forming the structural repair patch system of claim 29, the process comprising: forming the sealed enclosure by joining a removable attachment to the application member with a fastening surface.

49. The process of claim 48, wherein the fastening surface forms an adhesive seal.

50. The process of claim 48, wherein the fastening surface is defined by a mechanical fastener.

51. The process of claim 48, wherein the sealed enclosure is formed by compressing a surface of a containing member against an opposing surface of the application member.

52. The process of claim 51, wherein the compressing of surfaces is formed by a vacuum.

53. The process of claim 51, wherein the compressing of surfaces is formed by mechanical means.

54. The system of claim 29, wherein the top surface of the patch member: is shaped as an ellipse, is convex, or is conical.

55. The system of claim 29, wherein the product is a surfboard or other water sports product.

56. The system of claim 29, wherein the product is a marine vessel.
